(19) United States
(12) Patent Application Publication
(10) Pub. No.: US 2006/0077487 A1
(43) Pub. Date: Apr. 13, 2006

(54) Digital color fidelity

(75) Inventors: Michael L. Bevans, Jersey City, NJ (US); Braden Chattman, Brooklyn, NY (US); James Graham, Brooklyn, NY (US)

Correspondence Address: WILMER CUTLER PICKERING HALE AND DORR LLP, 60 STATE STREET, BOSTON, MA, 02109, US

(73) Assignee: Tribeca Imaging Laboratories, New York, NY (US)

(21) Appl. No.: 10/916,699

(22) Filed: Aug. 12, 2004

(51) Int. Cl. H04N 1/46

(52) U.S. Cl. 358/504

(57) ABSTRACT

A system and method manipulates and corrects the color of digital images. The invention addresses, inter alia, the problem of the differences in chromaticity of two systems by characterizing the chromaticity of the hues of a color model to minimize the perceived color difference between a digital image and its real world counterpart.

### FIELD OF THE INVENTION

The present invention relates to a corrective color system and a method and system for correcting the color of a digital image.

### DESCRIPTION OF RELATED ART

There exist many theoretical models that may provide a reasonable approximation of the human visual system, such as color spaces or color appearance models. These models provide a transformation between a native device color space and a particular human visual color space such as CIE XYZ. The CIE XYZ color space utilizes a set of spectral weighting functions that model human color perception. These functions, illustrated as curves and defined numerically, are referred to as the \overline{x}, \overline{y}, and \overline{z} color matching functions (CMFs) for the CIE Standard Observer and are shown in FIG. 1. As seen in FIG. 1, the color matching functions 100 include the \overline{x} weighting function 110, the \overline{y} weighting function 115, and the \overline{z} weighting function 120. Each of the color matching functions 100 is plotted for wavelengths of light ranging from 400 nm to 700 nm, which is approximately the range of human color perception. Examples of other well-known color models include linear Red-Green-Blue (RGB), nonlinear RGB, Hue-Saturation-Value (HSV), and Cyan-Magenta-Yellow (CMY).

While a color space ideally contains all information necessary to describe every color, for reasons of complexity, such “full color” spaces are difficult to implement in real world devices. As such, physical devices generally encode color using a “color coding” method, which can be simple and efficient at representing a wide range of colors.

Once a physical device, such as a digital camera, encodes an image of a physical object using, for example, additive RGB, the image can be converted into a data file and viewed on a standard color monitor using a standard computer. While the CIE XYZ color space and its derivates can be successful in achieving proper color management, there is currently a lack of an effective approach to reproduce with high fidelity the image capture information with the CIE and other color systems. Since there is no standard selection of primary colors (e.g., red, green, and blue), the image may appear differently as compared to the colors of the actual physical object itself, which forms the basis of the image. For example, a digital camera may have a different intensity response to a hue of red compared to the primary red phosphor used by the viewing monitor, resulting in an inaccurate rendition of the perceived reproduced color when compared to the physical object.

The tristimulus values of CIE are based upon a sampling from incandescent sources with color added using external filtration. The RGB model describes the production of color using phosphorescent sources. The chromaticity of these two systems is not the same. A result is that digital signals characterized by trichromatic theory (CIE) or by other color spaces and displayed using a phosphorescent emitter (RGB) produce images that are not accurately representative of their real world counterpart.

### SUMMARY OF THE INVENTION

The present invention addresses, inter alia, the problem of the differences in chromaticity of two systems by characterizing the chromaticity of the hues of a color model to minimize the perceived color difference between a digital image and its real world counterpart. Accordingly, the invention identifies a process for color correcting a digital image by establishing a simultaneous viewing evaluation for the express purpose of determining the color fidelity of an image recorded using a photoelectric sensor and the original subject of the recording.

It is an aspect of the present invention to provide a method and apparatus for more accurately rendering the color of digital images generated by an image capture device such as digital cameras, digital camcorders, digital video telephones, digital cellular telephones, and digital scanners. In doing so, the invention takes into account that when an image capture device employs a color model (e.g., a RGB color model) and is recording an image of a uniform blue hue, a change of the illumination or of the luminance of that hue (i.e., a change in the intensity of the blue light) is perceived by a human observer to be accompanied by a change in chromaticity. Thus, for a digital image to reproduce a change in illumination or luminance, the intensity values of the primary colors produced by the display device must, in general, vary even when the change in intensity is detected by the capture device to be occurring only along one primary color axis.

It is an aspect of the present invention to provide a method and system for relating the color of generated digital images, including at least three generated primary colors as defined in a color model, to the primary color intensities detected by the digital capture device, wherein at least one of the generated primary colors varies as a function of at least two of the detected primary color intensities.

It is an aspect of the present invention to provide a method and system for the generation of an image, the colors of which are comprised of at least three image primary colors, derived from at least three detected primary colors detected by an image capture device, wherein at least one of the image primary colors varies as a function of at least two detected primary colors.

It is an aspect of the present invention to provide a method and system for the correction of colors in a digital image of a real-life object, by implementing a data structure that relates acquired digital color values to corrected digital color values useful in producing a digital image, wherein said data structure was modified by a process comprising: comparing a real-life target of a first luminance to a first generated image, the first generated image being displayed using color values derived from the data structure to correspond to the acquired digital color values originating from the digital image capture device, altering the data structure if necessary until a color of the real-life target of the first luminance and the corresponding color of the first generated image match, comparing a second real-life target of a second luminance to a second generated image, the second generated image being displayed using color values derived from the altered data structure to correspond to the acquired digital color values originating from the digital image capture device, and altering the data structure if necessary until a color of the real-life target of the second luminance and the corresponding color of the second generated image match. It is another aspect of the invention to perform multiple comparison and alteration iterations for the same or different luminances.

It is also an aspect of the present invention to provide a method and system for better rendering and ameliorating the colors of an image comprised of at least three primary colors derived from the primary color information acquired by an image recording device, by manipulation of the primary color values or luminance values of the reproduced image in accordance with the principles elucidated hereinafter. The manipulation can include acquiring a reference digital image of a real-life, physical reference target on a viewing monitor; and comparing at least one color in the reference digital image with a corresponding color in the real-life reference target. By real-life reference target or physical reference target, we mean the physical object that is the subject of a digital image, i.e., the object whose likeness is reproduced in a digital image displayed on a viewing device or on printed media. The manipulation can include calibrating the viewing monitor and environmental conditions. The manipulation can include obtaining the uncorrected primary color values using a digital image capture device that defines the uncorrected primary colors in an additive RGB color space. As noted above, in this way, the method provides for color correcting an acquired digital reference image by establishing a simultaneous viewing evaluation to determine the color fidelity of the acquired image and the original reference target.

It is an aspect of the invention to store a first, second, and third color detected intensity of light measured by a digital image recording device, and replace the first, second, and third color detected intensities by a first, a second, and a third corrected color intensity, wherein each of the three corrected color intensities is a function of the value of at least two of the first, second and third detected color intensities, and output the first, second and third corrected color intensities for a data receiving device, which may be a display device or a storage medium, to include a magnetic, optical, or electronic storage medium. It is an aspect of the present invention to replace the first, second, and third color detected intensities by a first, a second, and a third corrected color intensity in accordance with an explicit relationship, to include a lookup table, derived by comparative analysis. It is an aspect of the invention to replace detected intensities and output corrected color intensities using electrical paths.

It is another aspect of the present invention for the explicit relationship to be determined by acquiring a reference digital image of a real-life reference target on a viewing monitor and comparing at least one color in the reference digital image with a corresponding color in the real-life reference target. It is an aspect that the explicit relationship be derived by a Digital Color Fidelity process, as described herein.

It is an aspect of the invention for systems and devices involved in manipulating the colors of digital images to be part of computers, semiconductor chips, display devices, to include computer monitors, digital television, cellular telephones, and digital video telephones, and apparatus that produce images on a printed medium, to include printers and facsimile machines.

The features and advantages of the present invention will be more readily apparent and understood from the following detailed description of the invention, which should be read in conjunction with the accompanying drawings and the claims appended to the end of the detailed description.

### BRIEF DESCRIPTION OF THE DRAWINGS

FIG. 1 is a diagram showing the three color matching functions \overline{x}, \overline{y}, \overline{z}, of CIE XYZ.

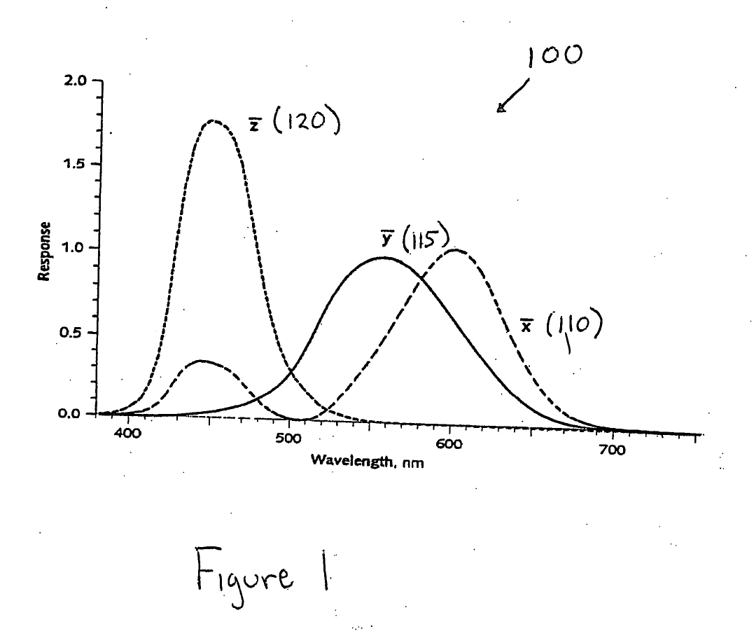

FIG. 2 is an exemplary color correction procedure according to the present invention.

FIG. 3 shows a Gretag MacBeth Color Checker.

FIG. 4 is an exemplary color evaluation procedure according to the present invention.

FIG. 5 shows a subtractive CMY color model.

FIG. 6 shows an exemplary evaluation and correction procedure according to the present invention.

FIG. 7 shows the relationship between the uncorrected and corrected primary color values that exist in an uncorrected color space and a corrected color space, respectively.

FIG. 8 shows various devices to capture, store, and reproduce images as well as ameliorate said image colors according to one embodiment.

FIGS. 9A, 9B, and 9C illustrate devices that can modify color data to more accurately render images according to various embodiments of the present invention.

### DETAILED DESCRIPTION

For purposes of illustration only, and not to limit the scope of the present invention, the invention will be explained with reference to the embodiments of the invention indicated in the drawings. One skilled in the art would understand that the present invention is not limited to the specific examples disclosed and can be more generally applied to methods and systems for relating the color of digital images to the primary color intensities detected by digital capture devices. Furthermore, as understood by one skilled in the art, the primary colors referred to herein are defined by the system or system user, and can be, for instance, an orthogonal set of three colors for a particular color space, like RGB or CMY, or, alternatively, the primary colors are arbitrarily chosen and are nonorthogonal (e.g., CMY or CMYRGB).

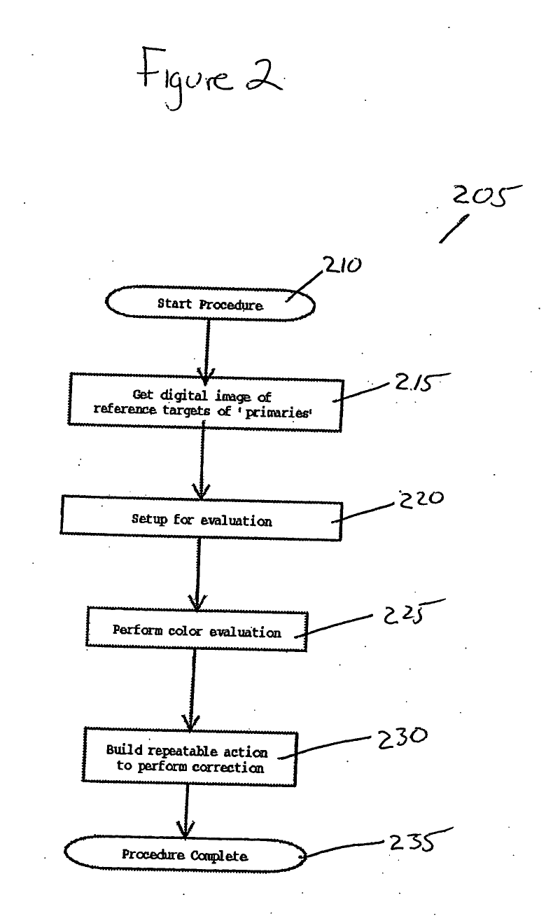

Referring to FIG. 2, a flow chart showing the functionality of an exemplary color correction procedure 205 is illustrated. Color correction procedure 205 is a method of comparative analysis (i.e., comparative color analysis). Color correction procedure 205 begins at start step 210 and proceeds to target acquisition step 215, in which a digital image of a reference target is obtained. Then, the color correction procedure 205 proceeds to calibration step 220, in which a viewing monitor, as well as environmental variables and conditions are calibrated and normalized. Then, evaluation step 225 is executed, in which the digital image of the reference target is evaluated and corrected. Using the results of the color correction and evaluation step 225, a repeatable procedure for color correction is constructed in procedure construction step 230. Then, color correction procedure 205 exits at exit step 235.

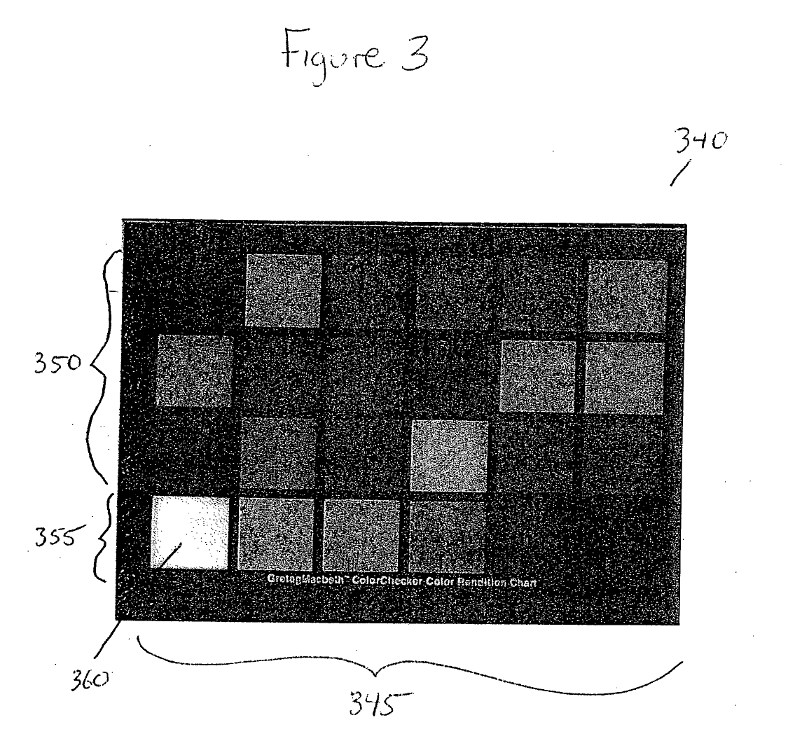

As described above, target acquisition step 215 acquires a digital image of a reference target, which may be any physical, real-life object, picture, drawing, etc., that is capable of being photographed and compared to the digital image of the reference target once acquired. The reference target may include, for example, a soda can, a soda bottle, a trademark, a photograph, a color card, a monkey, etc. One such possible reference target is the industry standard Gretag MacBeth Color Checker 340, as shown in FIG. 3.

Gretag MacBeth Color Checker 340 includes 24 colored squares 345, including shades of color 350, as well as a gray scale 355 from white to black. It is considered that the Gretag MacBeth Color Checker 340 is a good reference target because it is made of pure pigments, which are consistent in color.

Any standard recording device may be used to acquire the digital image, such as a digital camera, camcorder, or scanner. In one exemplary embodiment according to the present invention, an eyelike MF digital camera back is used, the camera back housing a Phillips semiconductor CCD attached to a Rollei X-Act camera body using a Rodenstock 105 mm lens with a shutter speed of 1/250 at aperture f8.

The environmental lighting conditions within which the digital image is acquired should be normalized and calibrated to equalize color density and to help reduce color cast caused by camera filtration and lighting conditions. If the Gretag MacBeth Color Checker 340 is used as the reference target, for example, illumination may be adjusted so that the white target 360 on the Gretay MacBeth Color Checker 340 measures at a value between 240 and 253 RGB (where each color has a range, in this example, of from 0 to 255). Illumination is provided using a Hensel Studiotechnik Strobe set at a color temperature of substantially 5400 degrees Kelvin and a softbox operating at 2300 Watts, to evenly illuminate the reference target Gretag MacBeth Color Checker 340. The white target 360 can be balanced using conventional methods, such as by employing proprietary software packaged with the digital camera used to acquire the digital image.

The digital image can be recorded in any digital format, such as pdf, TIF, jpeg, or a proprietary format, with or without compression. In one exemplary embodiment, the digital image is recorded in TIF format with no data compression.

After the digital image of the reference target is obtained in target acquisition step 215, environmental variables are calibrated in calibration step 220, so that the evaluation of the digital image in evaluation step 225 is not corrupted by ambient lighting conditions, monitor settings, etc. The environmental calibration step 220 is the calibration of the viewing environment, including calibration of a computer monitor on which the digital image will be evaluated. Monitor calibration can help ensure that the monitor is properly displaying the digital image of the reference target relative to the environment in which the monitor is viewed.

Before calibration of the monitor begins, however, the monitor should be turned on for at least half an hour to help ensure the stability of its display, after which the viewing environment should be calibrated, as described below. Then, the background color of the monitor should be set to a light neutral gray to help prevent the background color from interfering with the observer's color perception while calibrating the monitor. The hardware white point temperature of the monitor should be set in accordance with the type of monitor being used, so that the monitor exhibits a sufficiently high color temperature to better display the color space (e.g., additive RGB) used to display images. For example, with a Sony Trinitron Multiscan E400 monitor the hardware white point color temperature is set to approximately 9300 degrees Kelvin.

Furthermore, the environmental illumination should be set before monitor calibration to help ensure the best monitor calibration and color evaluation. The environmental illumination can be set to between 6000 and 7000 degrees Kelvin (i.e., the color temperature of normal diffuse daylight); for a diffuse daylight color profile the illumination is set to approximately 6550 Kelvin, as measured using a Minolta Color Meter IIIF. The illumination is important, since an observer's eye adapts to the brightest source of light, which should be the viewing monitor.

After the monitor's hardware white point is set and the viewing environment calibrated, monitor calibration is performed. Monitor calibration can include, for example, calibration of the monitor's contrast, brightness, gamma (midtones), and color balance to optimal settings. These settings are then used to characterize or create a profile (e.g., an ICC profile) for the monitor. To help determine these optimal settings, any conventional gamma adjustment tool can be used, such as the Adobe Gamma Control Panel of Adobe Photoshop software, which is produced by Adobe Systems, Inc. of Delaware.

Referring again to FIG. 2, after calibration step 220, evaluation step 225 of the color correction procedure 205 is executed. In this step, the colors of the digital image produced from the real-life reference target are evaluated and compared to the appearance of the real-life reference target itself. During this evaluation step, the viewing conditions should remain approximately similar to those used in calibrating the monitor, so that the evaluation of the digital image will not be corrupted, for example, by changes in illumination. In one exemplary embodiment according to the present invention, evaluation step 225 is performed in a white light viewing booth.

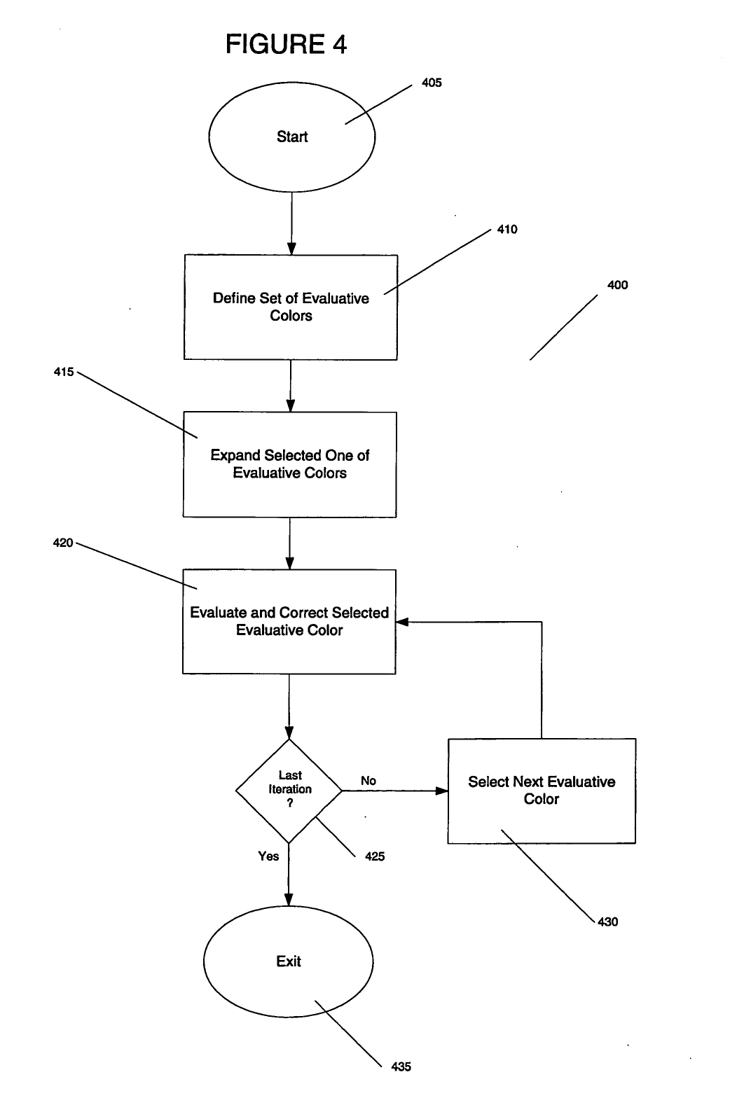

Referring now to FIG. 4, there is seen an exemplary evaluation procedure 400 for execution in evaluation step 225 of the color correction procedure 205.

The evaluation procedure 400 begins at start step 405 and proceeds to basic evaluative definition step 410, in which a set of basic evaluative colors is defined for evaluation and correction by the color correction procedure 205 according to the present invention. In one exemplary embodiment, red, green, and blue are selected as the set of basic evaluative colors. In another exemplary embodiment, red, green, blue, and yellow (RGBY) are selected. However, it should be appreciated that other colors may be selected for the set of basic evaluative colors, and the set of basic evaluative colors may contain any number of colors. For example, the set of basic evaluative colors may be selected in accordance with a set of colors provided by a customer, for example, a set of colors that may be identified with a particular product, such as 7-UP green or Coca Cola Red. In this manner, an exemplary color correction procedure 205 according to the present invention may preserve the likeness of a customer's product, thereby “normalizing” the color correction procedure 205 to a particular set of colors deemed important to the customer and, as such, worthy of more accurate correction.

After the set of basic evaluative colors is selected in evaluative color definition step 410, an expansion step 415 is executed, in which a selected one of the basic evaluative colors is expanded to fit the entire viewing surface of the monitor.

Next, evaluate and correct step 420 is executed, in which the basic evaluative color selected in expansion step 415 is evaluated and corrected.

Then, a query step 425 determines whether all colors in the set of basic evaluative colors have been evaluated and corrected. If not, a new color in the set of basic evaluative colors is selected in color selection step 430, this color then being evaluated and corrected in evaluate and correct step 420. After all the basic evaluative colors have been corrected once, query step 425 can direct step 430 to perform another iteration through the set of basic evaluative colors. Step 430 will select for a second time a color in the set of basic evaluative colors, this color then being re-evaluated and corrected in evaluate and correct step 420. After all the basic evaluative colors have been corrected twice, step 425 can determine an additional iteration. Step 425 can require a number of iterations pre-determined by the system user, or step 425 can determine if another iteration is necessary based upon the corrections made to the set of basic evaluative colors in the previous iteration. If the query indicates that the iteration is completed, the evaluation and correction procedure exits at exit step 435. In another embodiment, only one iteration cycle through the set of basic evaluative colors is performed.

The evaluate and correct step 420 operates to correct for color variations between the digital image of the reference target and the real-life reference target itself. For this purpose, an observer (e.g., an expert color observer or group of observers trained in the art of color comparison) compares the color of at least a portion of the digital image to the color of the corresponding portion of the real-life reference target itself, and modifies the color of the digital image color portion to better match the corresponding portion of the real-life reference target.

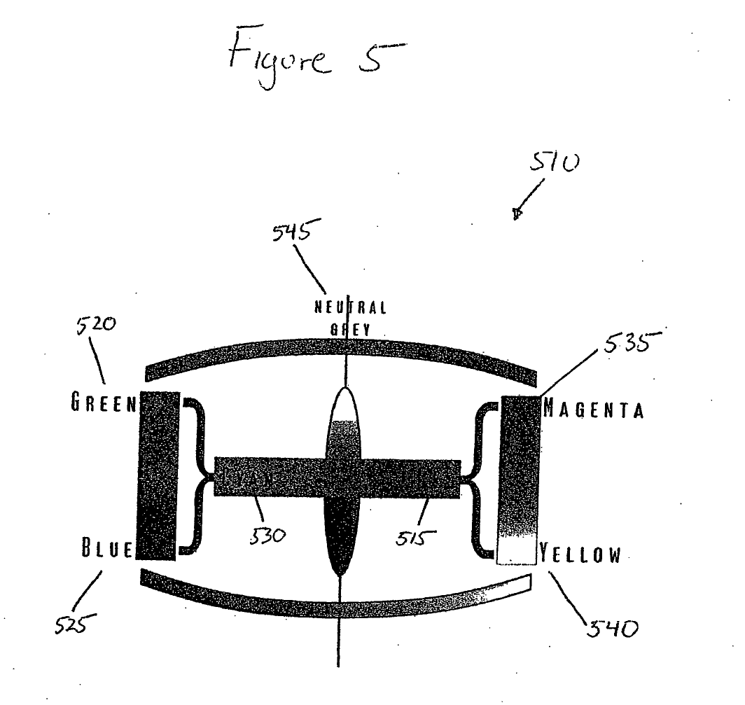

In one embodiment, a subtractive CMY evaluation and correction procedure is used to correct color variations between the digital image of the reference target and the real-life reference target itself. For this purpose, there is seen a discriminative CMY color model 510 in FIG. 5. Color model 510 may be used by an observer to evaluate the color of, for example, the digital image of the reference target. Color model 510 displays both the additive primary colors red 515, green 520, and blue 525, as well as their corresponding subtractive primaries cyan 530, magenta 535, and yellow 540. Additionally, the model 510 displays a gray scale with reference to neutral gray 545.

In this manner, the observer evaluates one (e.g., red) of the basic evaluative colors selected in step 410, which also exists in the digital image and the real-life reference target itself. Then, the observer compares the (red) in the digital image to the corresponding (red) of the real-life reference target. Using, for example, a subtractive CMY correction procedure, the observer may, for example, add cyan (or subtract both magenta and yellow) to the digital image if the (red) of the digital image is too red as compared to the corresponding (red) of the real-life reference target. An exemplary list of corrective color combinations for a subtractive CMY evaluation and correction process are listed below in the following chart:

| Basic | Subtractive | Subtractive | Additive | Additive |
|---|---|---|---|---|
| color | Corrective | Corrective | Corrective | Corrective |
| Selected | color | color | color | color |
| in Step | combination | combination | combination | combination |
| 410 | choice 1 | choice 2 | choice 3 | choice 4 |
| Too Cyan | Subtract Cyan | Add both | Add Red | Subtract |
| | (−Cy) | Magenta and | (+Rd) | both Green |
| | | Yellow | | and Blue |
| | | (+Mg, +Yl) | | (−Gr, −Bl) |
| Too Blue | Add Yellow | Subtract both | Subtract | Add both |
| | (+Yl) | Cyan and | Blue (−Bl) | Red and |
| | | Magenta | | Green |
| | | (−Cy, −Mg) | | (+Rd, +Gr) |
| Too Green | Add Magenta | Subtract both | Subtract | Add both |
| | (+Mg) | Cyan and | Green | Red and |
| | | Yellow | (−Gr) | Blue |
| | | (−Cy, −Yl) | | (+Rd, +Bl) |
| Too Red | Add Cyan | Subtract both | Subtract Red | Add both |
| | (+Cy) | Magenta and | (−Rd) | Green and |
| | | Yellow | | Blue |
| | | (−Mg, −Yl) | | (+Gr, +Bl) |
| Too | Subtract | Add both Cyan | Add Green | Subtract |
| Magenta | Magenta (−Mg) | and Yellow | (+Gr) | both Red and |
| | | (+Cy, +Yl) | | Blue |
| | | | | (−Rd, −Bl) |
| Too | Subtract | Add both Cyan | Add Blue | Subtract |
| Yellow | Yellow (−Yl) | and Magenta | (+Bl) | both Red and |
| | | (+Cy, +Mg) | | Green |
| | | | | (−Rd, −Gr) |
| Too Dark | Add neutral | — | | |
| | density | | | |
| Too Light | Subtract | — | | |
| | neutral density | | | |

Thus, for example, if a target color in the digital image is both too cyan and too blue, an observer may correct the color discrepancy, for example, by subtracting cyan (−Cy) (to correct for too cyan) and adding yellow (+Y1) (to correct for too blue). Alternatively, instead of subtracting cyan to correct for too cyan, the observer may add both magenta and yellow (+Mg, +Y1) (to correct for too cyan). Further, instead of adding yellow to correct for too blue, the observer may subtract both cyan and magenta (−Cy, −Mg) (to correct for too blue). This results in four choices to correct for a basic evaluative color using the “subtractive primaries” CMY:
a) subtracting cyan to correct for too cyan and adding yellow to correct for too blue (−Cy, +Y1);
b) subtracting cyan to correct for too cyan and subtracting both cyan and magenta to correct for too blue (−−Cy, −Mg);
c) adding both magenta and yellow to correct for too cyan and subtracting both cyan and magenta to correct for too blue (−Cy, +Y1); and
d) adding both magenta and yellow to correct for too cyan and adding yellow to correct for too blue (+Mg, ++Y1).

The observer may, for example, perform all four color corrections separately, and then choose the color correction that appears to better correct for the color discrepancy.

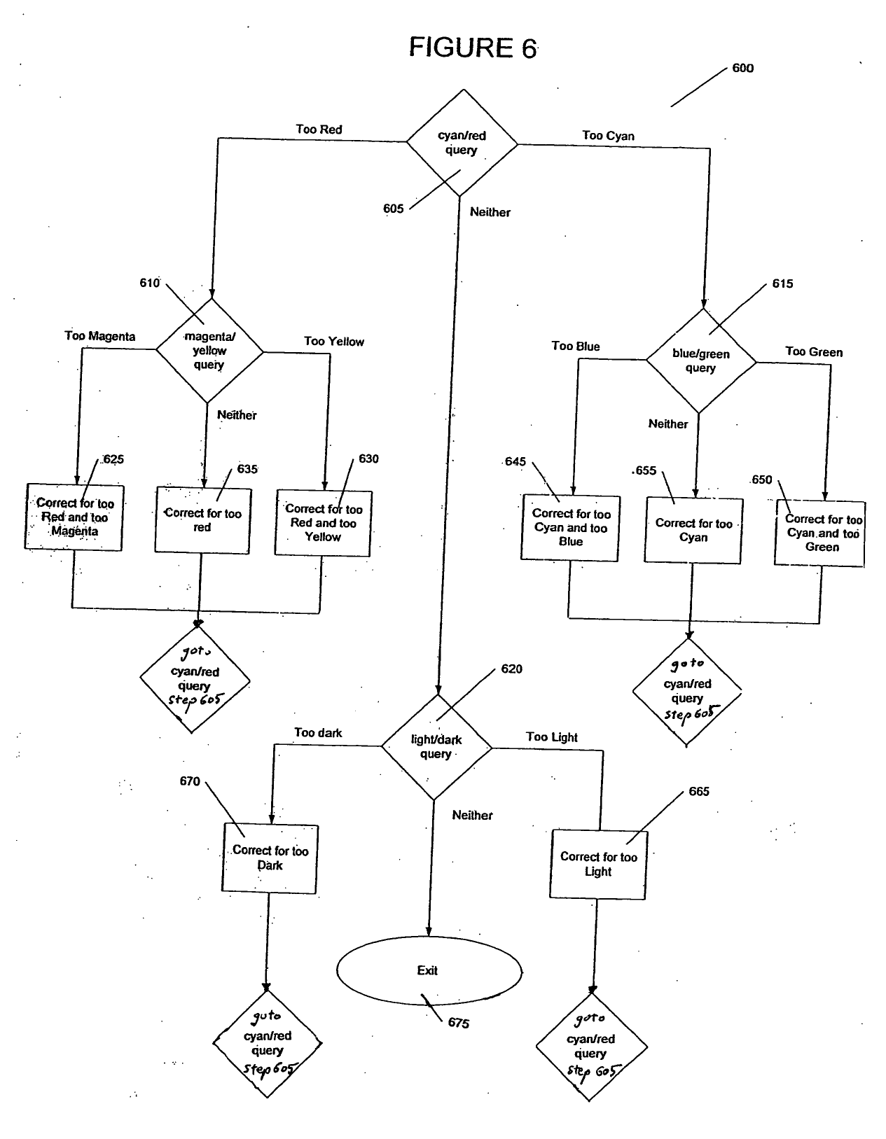

Referring now to FIG. 6, there is seen an exemplary evaluation and correction procedure 600 of step 420 of FIG. 4. Evaluation and correction procedure 600 begins at cyan/red query step 605, in which the observer evaluates the digital image of the reference target and determines whether the basic evaluative color selected in step 410 (which is also present in the digital image of the reference target) is too cyan, too red, or neither too cyan nor too red. If the observer determines that the basic evaluative color in the digital image is too red, magenta/yellow query step 610 is executed. Alternatively, if the observer determines that the basic evaluative color in the digital image is too cyan, blue/green query step 615 is executed. Or, if the observer determines that the basic evaluative color in the digital image is neither too red nor too cyan, light/dark query step 620 is executed.

If the observer determines that the basic evaluative color in the digital image is too red, magenta/yellow query step 610 is executed, in which the observer determines whether the basic evaluative color in the digital image is too magenta, too yellow, or neither too magenta nor too yellow. If the observer determines that the basic evaluative color in the digital image is too magenta, red/magenta correction step 625 is executed, in which the excess red and magenta is corrected for by one of the following choices:

| Basic evaluative color both | Resulting Color Correction |
|---|---|
| too Red and too Magenta | Combination |
| Add Cyan to correct for too | (+Cy, −Mg) |
| Red (+Cy); subtract Magenta | |
| to correct for too Magenta | |
| (−Mg) | |
| Add Cyan to correct for too | (++Cy, +Yl) |
| red (+Cy); add both Cyan and | |
| Yellow to correct for too | |
| Magenta (+Cy, +Yl) | |
| Subtract both Magenta and | (−−Mg, −Yl) |
| Yellow to correct for too Red | |
| (−Mg, −Yl); subtract Magenta | |
| to correct for too Magenta | |
| (−Mg) | |

The observer can, for example, perform all three of the above color corrections and then choose which of the three choices appears to best correct for the color discrepancy.

Alternatively, if the observer determines, from magenta/yellow query step 610, that the basic evaluative color in the digital image is both too red and too yellow, red/yellow correction step 630 is executed, in which the excess red and yellow is corrected for by one of the following choices:

| Basic evaluative color both | Resulting Color Correction |
|---|---|
| too Red and too Yellow | Combination |
| Add Cyan to correct for too Red | (+Cy, −Yl) |
| (+Cy); subtract Yellow to | |
| correct for too yellow (−Yl) | |
| Add Cyan to correct for too Red | (++Cy, +Mg) |
| (+Cy); add both Cyan and | |
| Magenta to correct for too | |
| Yellow (+Cy, +Mg) | |
| Subtract both Magenta and | (−Mg, −−Yl) |
| Yellow to correct for too Red | |
| (−Mg, −Yl); subtract Yellow to | |
| correct for too Yellow (−Yl) | |

The observer can, for example, perform all three of the above color corrections and then choose which of the three choices appears to best correct for the color discrepancy.

Alternatively, if the observer determines, from magenta/yellow query step 610, that the basic evaluative color in the digital image is too red, but neither too magenta nor too yellow, red correction step 635 is executed, in which the excess red is corrected for by one of the following choices:

| | Resulting Color Correction |
|---|---|
| Basic evaluative color too Red | Combination |
| Add Cyan to correct for too Red | (+Cy) |
| (+Cy) | |
| Subtract both Magenta and | (−Mg, −Yl) |
| Yellow to correct for too Red | |
| (−Mg, −Yl) | |

The observer can, for example, perform both of the above color corrections and then choose which of the two choices appears to best correct for the color discrepancy.

If the observer determines, in cyan/red query step 605, that the basic evaluative color in the digital image is too cyan, blue/green query step 615 is executed, in which the observer determines whether the basic evaluative color in the digital image is too blue, too green, or neither too blue nor too green. If the observer determines that the basic evaluative color in the digital image is too blue, cyan/blue correction step 645 is executed, in which the excess cyan and blue is corrected for by one of the following choices:

| Basic evaluative color both too | Resulting Color Correction |
|---|---|
| Cyan and too Blue | Combination |
| Subtract Cyan to correct for too | (−Cy, +Yl) |
| Cyan (−Cy); add Yellow to correct | |
| for too Blue (+Yl) | |
| Subtract Cyan to correct for too | (−−Cy, −Mg) |
| Cyan (−Cy); subtract both Cyan | |
| and Magenta to correct for too | |
| Blue (−Cy, −Mg) | |
| Add both Magenta and Yellow to | (+Mg, ++Yl) |
| correct for too Cyan (+Mg, +Yl); | |
| add Yellow to correct for too Blue | |
| (+Yl) | |

The observer can perform all three of the above color corrections and then choose which of the three choices appears to best correct for the color discrepancy.

Alternatively, if the observer determines, from blue/green query step 615, that the basic evaluative color in the digital image is both too cyan and too green, cyan/green correction step 650 is executed, in which the excess cyan and green is corrected for by one of the following choices:

| Basic evaluative color both too | Resulting Color Correction |
|---|---|
| Cyan and too Green | Combination |
| Subtract Cyan to correct for too Cyan | (−Cy, +Mg) |
| (−Cy); add Magenta to correct for too | |
| Green (+Mg) | |
| Subtract Cyan to correct for too Cyan | (−−Cy, −Yl) |
| (−Cy); subtract both Cyan and Yellow | |
| to correct for too Green (−Cy, −Yl) | |
| Add both Magenta and Yellow to | (++Mg, +Yl) |
| correct for too Cyan (+Mg, +Yl); add | |
| Magenta to correct for too Green | |
| (+Mg) | |

The observer can perform all three of the above color corrections and then choose which of the three choices appears to best correct for the color discrepancy.

Alternatively, if the observer determines, from blue/green query step 615, that the basic evaluative color in the digital image is too cyan, but neither too blue nor too green, cyan correction step 655 is executed, in which the excess cyan is corrected for by one of the following choices:

| | Resulting Color Correction |
|---|---|
| Basic evaluative color too Cyan | Combination |
| Subtract Cyan to correct for too | (−Cy) |
| Cyan (+Cy) | |
| Add both Magenta and Yellow to | (+Mg, +Yl) |
| correct for too Cyan (+Mg, +Yl) | |

The observer can perform both of the above color corrections and then choose which of the two choices appears to best correct for the color discrepancy.

It should be noted that, although the various exemplary embodiments described above recite specific color correction combinations for correcting color discrepancies in the set of basic evaluative colors, there exist an infinite number of color combinations to correct for a particular color discrepancy, and these color combinations may include one or more of an infinite number of colors. Accordingly, this description is not intended to be limited to the color combinations to those above, but rather is intended to cover any and all corrective color combinations for correcting color discrepancies in any of the basic evaluative colors selected in step 410.

After the selected one of the color correction steps 625, 630, 635, 645, 650, 655 is executed, the cyan/red query step 605 is repeated. If the observer determined, in cyan/red query step 605, that the basic evaluative color in the digital image is neither too red nor too cyan, light/dark query step 620 is executed, in which it is determined whether the basic evaluative color in the digital image is too light or too dark. If the observer determines that the basic evaluative color in the digital image is too light, light correction step 665 is executed, in which the excess lightness of the basic evaluative color in the digital image is corrected for by subtracting neutral density. Alternatively, if the observer determined, in light/dark query step 620, that the basic evaluative color in the digital image is too dark, dark correction step 670 is executed, in which the excess darkness of the basic evaluative color in the digital image is corrected for by adding neutral density. After executing step 665 or 670, the cyan/red query step 605 is repeated.

Alternatively, if the observer determined, in light/dark query step 660, that the basic evaluative color in the digital image is neither too light nor too dark, the evaluation and correction procedure ends at exit step 675.

The evaluation and correction procedure 600, begins at cyan/red query 605 and does not end until reaching step 675, even though executing step 605 more than once before reaching step 675. As shown in FIG. 4, the evaluation and correction procedure 600, which is executed in step 420, is performed once per iteration for each color in the selected group of colors defined in the evaluative definition step 410.

Once the evaluation and correction procedure is performed for all colors in the set of basic evaluative colors defined in step 410 of FIG. 4, the evaluation step 225 of FIG. 2 ends, and the construction step 230 is executed. In construction step 230, a repeatable procedure for color correction is constructed. For this purpose, the corrective color combinations produced by the evaluation and correction procedure 420 for each of the colors defined in step 410 may be written, along with interpolated values, if desired, to a corrective sequence file, which is be saved, for example, on the hard drive of a computer, a floppy disk, or any other storage medium. Alternatively, the corrective results from the above corrective procedures 205 and 420 can be implemented in hardware, such as, for example, discrete logic, a Field Programmable Gate Array (FPGA), or an Application Specific Integrated Circuit (ASIC). Whether implemented in hardware or software, however, the corrective color combinations for each of the colors defined in step 410 can be used to correct the color of any subsequent digital image, for example, a digital image of a flower, a monkey, a landscape, etc, by use of the explicit relationship discussed herein. After correction, the colors of the image are more faithful to the colors of the real-world target object, as perceived by a qualified observer.

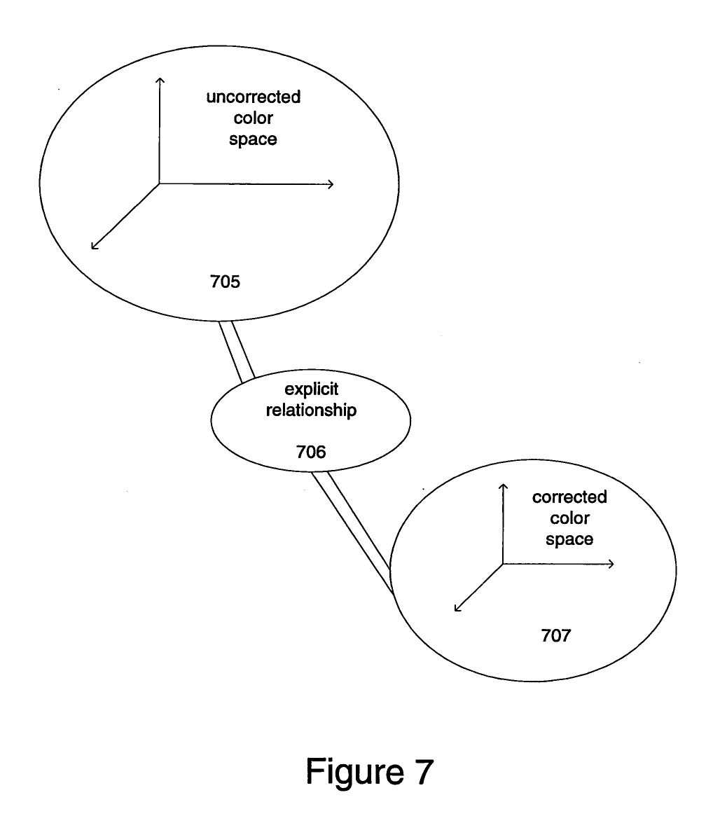

It should be noted that, although the various exemplary embodiments described hereinabove generally teach how evaluation and correction procedures can be used to improve the color fidelity of an image, the present invention is not limited to the above evaluative, iterative procedure. Instead, in one embodiment of the present invention depicted in FIG. 7, there is a relationship 706 between uncorrected and corrected primary color luminance or intensity values, which exist, for example, in an uncorrected color space 705 and a corrected color space 707. The explicit relationship 706 between the corrected and uncorrected colors can be derived by the evaluative procedures taught herein, or it can have been derived by another method, but the relationship 706 is explicitly defined in for example, a matrix, a transformation table, a lookup chart, a computer algorithm, an electronic circuit, or in another explicit relationship known to one skilled in the art. The relationship 706 can also include values that were interpolated between color values that were actually corrected by the evaluative procedures described above, or the relationship 706 can be adapted to permit an algorithm or a processor to interpolate color values from those included in relationship 706.

The relationship 706 is informed by the knowledge that when an image capture device detects an image of a hue (e.g., a red hue), a change of the illumination of that hue (e.g., a change in the intensity of the red light) is perceived by the human eye to be accompanied by a change in chromaticity; for a digital image to reproduce the colors of the changed illumination with fidelity, the intensity values of the primary colors produced by the display device must, in general, vary even when the change in intensity is detected by the capture device to be occurring only along one primary color axis. The same is true for different luminance values of a hue as for a change in illumination of a hue. The relationship 706 can map each uncorrected primary color luminance value in the space 705 to a corrected primary luminance color value in the corrected color space 707.

In one embodiment, a color corrected digital image has plural colors, and the colors themselves are, in general, composed of at least three corrected primary colors according to a color model. The corrected primary colors are related by an explicit relationship, as described hereinabove, to the uncorrected primary colors derived from a digital image capture device, wherein each of the corrected primary colors are multiply dependent upon (i.e., can be each a multivariable function of) the uncorrected primary colors. Alternatively, fewer than all of the corrected primary colors each vary as a function of all of the uncorrected primary colors, and in another embodiment, only one corrected primary color is a function of all the uncorrected primary colors. In one embodiment, a corrected primary color can be a function of fewer than all the uncorrected primary colors. In another embodiment, at least one corrected primary color varies as a function of at least two uncorrected primary colors.

The tristimulus values of CIE are based upon a sampling from incandescent sources with color added using external filtration. The RGB model, describes the production of color using phosphorescent sources. The chromaticity of these two systems, CIE and RGB, is not the same. In another embodiment of the present invention, the characterization of the CIE data by the color correction process of relating the corrected and uncorrected colors by an explicit relationship as described hereinabove is termed Digital Color Fidelity (“DCF”). DCF is a characterization of CIE data that defines the chromaticities of the hues of a color model (e.g., RGB or CMY) based on a method of comparative analysis, which results in a more visually color accurate digital image. DCF can be developed by the DCF process: comparing a digital image of a reference target to the real world reference target and adjusting the individual hues of the digitally rendered reference target to minimize the perceived differences between the two, as described hereinabove. In particular, the DCF Process is a process for color correcting a digital image by establishing a simultaneous viewing evaluation for the express purpose of determining the color fidelity of an image recorded using a photoelectric sensor and the original subject of the recording.

DCF produces hues, whose chromaticity is not perceptually uniform and not mathematically constant. The DCF characterization of the chromaticity of the hues differs from the default chromaticity of the hues in the RGB color model. In general, the DCF characterization of the chromaticity of the hues differs from the RGB default as follows:
Blue at low luminance values is darker and redder;
Blue at medium luminance values is equally light and redder;
Blue at high luminance values is darker and redder.
Green at low luminance values is lighter, redder, and bluer;
Green at medium luminance values is equally light, redder, and bluer;
Green at high luminance values is equally light, redder, and less blue.
Red at low luminance values is darker, less red, and bluer;
Red at medium luminance values is unchanged;
Red at high luminance values is equally light and less blue.
Yellow at low luminance values is lighter and greener;
Yellow at medium luminance values is equally light;
Yellow at high luminance values is equally light and less blue.
Magenta at low luminance values is equally light, greener, and bluer;
Magenta at medium luminance values is lighter and greener;
Magenta at high luminance values is lighter and greener.
Cyan at low luminance values is darker, redder, and less blue;
Cyan at medium luminance values is equally light and redder;
Cyan at high luminance values is unchanged.

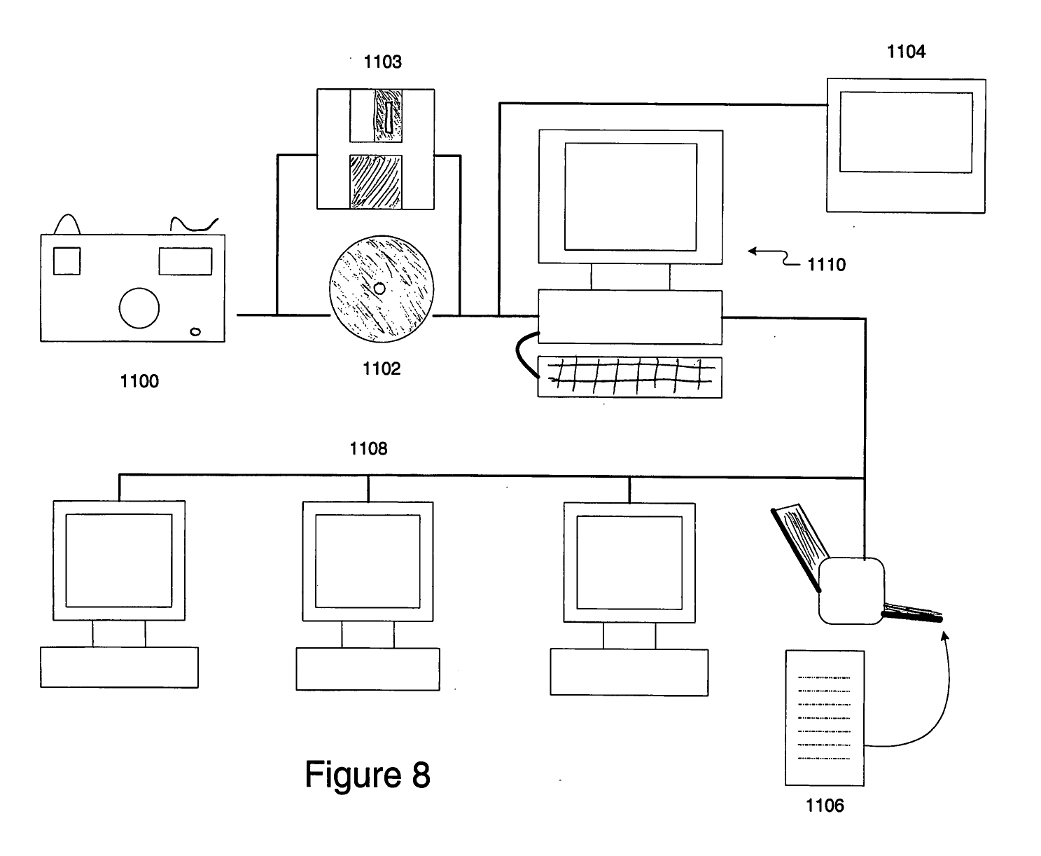

Referring to FIG. 8, in one embodiment of the present invention, the data comprising the digital image can be recorded by any image recording or image capture device 1100, which can be a document scanner, a video telephone, a cellular telephone, a digital video recorder, and a digital camera, or another image capture device known to one skilled in the art. The color corrected digital image and related data can be stored before and after the color correction process that relates the corrected and uncorrected colors by an explicit relationship as described in conjunction with FIG. 7. The data can be stored on any volatile or non-volatile memory, and can be stored on any electronic, magnetic, or optical medium, including a MiniDisc, a CD 1102, a floppy disk 1103, a hard drive, a Flash RAM, or other storage device known to one skilled in the art. The color corrected digital image can be displayed on a visual display device 1104, including a computer monitor, a television, and a telephone, and the color corrected image can be reproduced in a printed medium 1106, including by a printer and a facsimile machine. The color corrected digital image can be transmitted over a computer network 1108. The systems and methods of the present invention do not preclude translating the digital image into another color model having different primary colors either before or after the color correction process, using, for example, a computer system 1110.

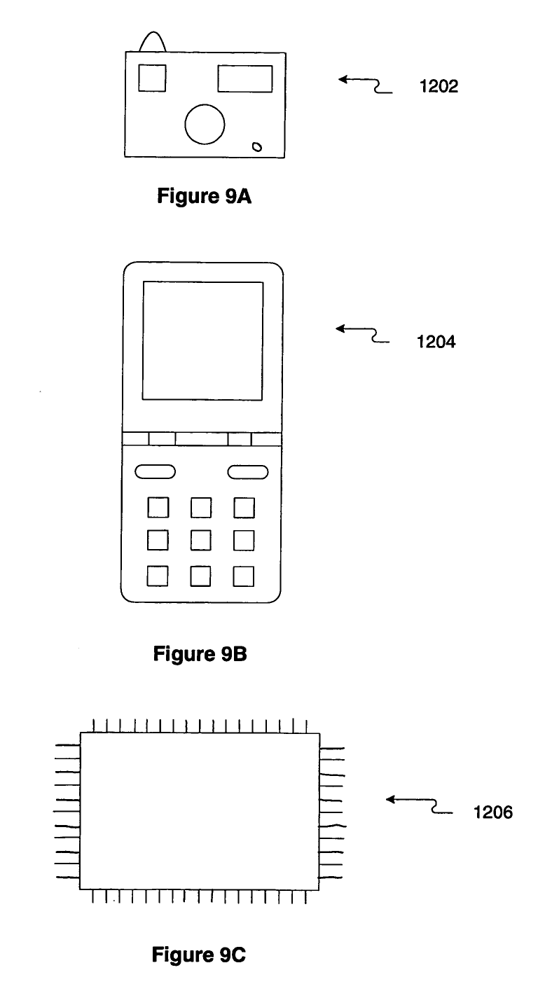

In one embodiment of the present invention, the color correction process of relating the corrected and uncorrected colors by an explicit relationship as described in conjunction with FIG. 7 above occurs on a computer (e.g., on computer 1110 in FIG. 8), on a network server, or over a network (e.g., on computer network 1108). Referring to FIG. 9A, in one embodiment, the color correction process occurs on the digital image capture device 1202. Alternatively, referring to FIG. 9B, the color correction process occurs at the image display device 1204 or at the printer (e.g., printer 1106 in FIG. 8). The explicit relationship and the algorithm to replace the uncorrected color data by the corrected color data as specified by the relationship can be stored on a computer, on data storage media, or, referring to FIG. 9C, on a semiconductor chip 1206.

Having described the embodiments of the invention, it should be apparent that various combinations of embodiments may be made or modifications added thereto as is known to those skilled in the art without departing from the spirit and scope of the invention.

What is claimed is:

1. A method for enabling the correction of data representing digital images, comprising:
receiving a first, a second, and a third uncorrected primary color digital value that, in different combinations of said digital values, are produced by colors present in a viewed image;
providing a first, a second, and a third corrected primary color digital value that, in different combinations of said digital values, produce a range of colors in a corrected digital image; and
relating, for a combination of said first, second, and third uncorrected primary color digital values, a corresponding combination of said first, second, and third corrected primary color digital values, wherein the first corrected primary color digital value in a corrected color digital value combination is responsive to a change in any one of the uncorrected primary color digital values in the corresponding uncorrected color digital value combination.

2. The method for manipulating the colors of digital images according to claim 1, wherein relating the values of the uncorrected primary colors to the corrected primary colors comprises:
acquiring a reference digital image of a real-life reference target on a viewing monitor; and
comparing at least one color in the reference digital image with a corresponding color in the real-life reference target.

3. The method for manipulating the colors of digital images according to claim 2, wherein relating the values of the uncorrected primary colors to the corrected primary colors further comprises:
calibrating the viewing monitor; and
calibrating environmental illumination.

4. The method for manipulating the colors of digital images according to claim 1, wherein:
the value of the second corrected primary color is responsive to a change in the value of any one of the uncorrected primary colors.

5. The method for manipulating the colors of digital images according to claim 4, wherein:
the value of the third corrected primary color is responsive to a change in the value of any one of the uncorrected primary colors.

6. The method for manipulating the colors of digital images according to claim 1, wherein relating the values of the uncorrected primary colors to the corrected primary colors comprises:
acquiring a reference digital image with a digital image capture device for display on a viewing monitor;
comparing a color of a first luminance value displayed on the viewing monitor with its corresponding color in a real-life reference target; and
comparing a color of a second luminance value displayed on the viewing monitor with its corresponding color in a real-life reference target.

7. The method for manipulating the colors of digital images according to claim 6, wherein relating the values of the uncorrected primary colors to the corrected primary colors further comprises:
calibrating the viewing monitor; and
calibrating environmental illumination.

8. The method for manipulating the colors of digital images according to claim 7, wherein the digital image capture device defines the uncorrected primary colors in an additive RGB color space.

9. A method for correction of colors of digital images, comprising:
defining first, second and third uncorrected primary colors that, by variation of the intensity values of the uncorrected primary colors, produce a range of colors present in an uncorrected digital image;
defining first, second, and third corrected primary colors that, by variation of the intensity values of the corrected primary colors, produce a range of colors present in a corrected digital image;
defining a lookup table that indicates for selected combinations of intensity values of the first, second, and third uncorrected primary colors, a corresponding combination of intensity values of the first, second, and third corrected primary colors, wherein:
a modification in the intensity value of any one of the first, second, and third uncorrected primary colors of the combination requires modification of each of the first, second, and third corrected primary colors of the corresponding combination; and
substituting the intensity values of the corrected primary colors for the intensity values of the uncorrected primary colors.

10. A method for correcting colors of digital images, comprising:
defining a first, a second, and a third uncorrected primary color that, in different combinations of values of said uncorrected primary colors, produce a range of colors for representing an uncorrected digital image;
providing a first, a second, and a third corrected primary color that, in different combinations of said corrected primary colors, produce a range of colors for representing a corrected digital image; and
providing an explicit relationship that relates, for each combination of values of said first, second, and third uncorrected primary colors, a corresponding combination of values of said first, second, and third corrected primary colors, wherein a variation in a value included in the uncorrected primary color combination affects all three values included in the corrected primary color combination.

11. A system for correction of colors of digital images, comprising:
a first input module that stores a first color detected intensity of light measured by a digital image recording device;
a second input module that stores a second color detected intensity of light measured by the digital image recording device;
a third input module that stores a third color detected intensity of light measured by the digital image recording device;
a module for replacing the first, second, and third color detected intensities by a first, a second, and a third corrected color intensity, wherein the three corrected color intensities is a function of the value of at least two of the first, second and third detected color intensities; and
an output module that outputs the first, second and third corrected color intensities for a data receiving device.

12. A magnetic storage medium for storing a computer program using modules, said modules comprising:
a first input module that reads a first color detected luminance value measured by a digital image recording device;
a second input module that reads a second color detected luminance value measured by the digital image recording device;
a third input module that reads a third color detected luminance value measured by the digital image recording device;
a module for replacing a each set of the first, second, and third color luminance values by first, second, and third corrected color luminance values, wherein the first, second, and third corrected color luminance values are each a function of at least one of the first, second and third detected color luminance values;
an output module that outputs the first, second and third corrected color luminance values for a data receiving device; and
the value replacing module utilizes an explicit relationship derived by a comparative analysis.

13. A magnetic storage medium for storing a computer program using modules according to claim 12, wherein:
the value replacing module utilizes an explicit relationship derived by a Digital Color Fidelity process.

14. A device for manipulating the colors of digital images, comprising:
at least one electrical path to conduct data relating to uncorrected values of a first, a second, and a third primary color;
at least one electrical path to conduct data relating to corrected values of a first, a second, and a third primary color;
a first module that identifies a first set comprised of the first, second and third primary color corrected values upon receipt of a second set comprised of the first, second, and third primary color uncorrected values, in which first set all of the first, second, and third primary color corrected values change in response to a change in any of the values of the second set;
a second module that replaces the second set by the first set identified by the first module; and
the first set changes in response to a change in any of the values of the second set according to an explicit relationship, the explicit relationship being determined by acquiring a reference digital image of a real-life reference target on a viewing monitor and comparing a plurality of colors in the reference digital image with corresponding colors in the real-life reference target.

15. A device for manipulating the colors of digital images according to claim 14, wherein:
the explicit relationship is determined by a Digital Color Fidelity process.

16. A device for manipulating the colors of digital images according to claim 14, wherein:
the data concerning the uncorrected values of a first, a second, and a third primary color are obtained by a digital image capture device that defines the uncorrected primary colors in an additive RGB color space.

17. The device of claim 16, wherein the paths and modules are part of the digital image capture device.

18. The device of claim 17, wherein the digital image capture device is selected from the group consisting of a digital camera, a digital video recorder, a digital cellular telephone, a digital video telephone, and a scanner.

19. A system for correcting colors of digital images, comprising:
means for receiving a first, a second, and a third uncorrected primary color that, in different combinations of values of said uncorrected primary colors, produce a range of colors present in an uncorrected digital image;
means for providing a first, a second, and a third corrected primary color that, in different combinations of said corrected primary colors, produce a range of colors present in a corrected digital image; and
means for relating, for each combination of values of said first, second, and third uncorrected primary colors, a corresponding combination of values of said first, second, and third corrected primary colors, wherein variations in any one of the values included in the uncorrected primary color combination affects all three values included in the corrected primary color combination.

20. The system according to claim 19, wherein the relating means is based upon a comparative analysis of the digital image colors comprising:
means for acquiring a reference digital image of a real-life reference target on a viewing monitor; and
means for comparing at least one color in the reference digital image with a corresponding color in the real-life reference target.

21. A method for creating a device for manipulating the colors of digital images, comprising: calibrating a viewing monitor;
receiving uncorrected combinations of a first, a second, and a third primary color digital value that, in different combinations of said digital values, are produced respectively by colors present in a real-life reference target through a digital image acquisition device;
providing each said uncorrected combination of values to the monitor for displaying a respective uncorrected color image;
comparing and correcting each said uncorrected color image to match the color of the real-life target which generated it;
determining corrected combinations of a first, a second, and a third primary color digital value that represents the corrected color images for each different uncorrected combination of digital values, for producing a plurality of said corrected combinations over a range of colors in a reference digital image of a real-life reference target; and
deriving from the combinations of corrected and uncorrected values a relationship that relates, for each uncorrected combination of said first, second, and third primary color digital values, a corresponding corrected combination of said first, second, and third primary color digital values.

22. A method of modifying a data structure, said data structure relating original digital color values originating from a digital image capture device to digital color values useful in producing a digital image, said method comprising:
comparing a real-life target of a first luminance to a first generated image, the first generated image being displayed using color values derived from the data structure to correspond to the acquired digital color values originating from the digital image capture device;
altering the data structure if necessary until a color of the real-life target of the first luminance and the corresponding color of the first generated image match;
comparing a second real-life target of a second luminance to a second generated image, the second generated image being displayed using color values derived from the altered data structure to correspond to the acquired digital color values originating from the digital image capture device; and
altering the data structure if necessary until a color of the real-life target of the second luminance and the corresponding color of the second generated image match.

23. An apparatus for correcting colors in a digital image of a real-life object, comprising:
a module that receives digital color values acquired by a digital image capture device;
a data structure that relates acquired digital color values to corrected digital color values useful in producing a digital image, wherein said data structure was modified by a process comprising:
comparing a real-life target of a first luminance to a first generated image, the first generated image being displayed using color values derived from the data structure to correspond to the acquired digital color values originating from the digital image capture device;
altering the data structure if necessary until a color of the real-life target of the first luminance and the corresponding color of the first generated image match;
comparing a second real-life target of a second luminance to a second generated image, the second generated image being displayed using color values derived from the altered data structure to correspond to the acquired digital color values originating from the digital image capture device; and
altering the data structure if necessary until a color of the real-life target of the second luminance and the corresponding color of the second generated image match; and
a module that outputs the corrected digital color values.
